(19) United States
(12) Patent Application Publication
(10) Pub. No.: US 2019/0092345 A1
(43) Pub. Date: Mar. 28, 2019

(54) DRIVING METHOD, VEHICLE-MOUNTED DRIVING CONTROL TERMINAL, REMOTE DRIVING TERMINAL, AND STORAGE MEDIUM

(71) Applicant: BOE TECHNOLOGY GROUP CO., LTD., Beijing (CN)

(72) Inventor: Lin Zhu, Beijing (CN)

(21) Appl. No.: 16/024,896

(22) Filed: Jul. 1, 2018

(30) Foreign Application Priority Data
Sep. 22, 2017 (CN) 201710867195.3

(51) Int. Cl. B60W 50/14; B60W 50/00; G05D 1/00

(52) U.S. Cl. CPC B60W 50/14; B60W 50/00; G05D 1/0016; B60W 2050/0064; B60W 2050/146; B60W 2550/404; G05D 1/0038

(57) ABSTRACT

The present disclosure provides in some embodiments a driving method, including steps of: collecting vehicle information in real time, the vehicle information including whole-view information about a driving scene; transmitting the vehicle information to a remote driving terminal, so that the remote driving terminal generates and displays a current virtual reality scene of the vehicle in accordance with the vehicle information and receives a control instruction to generate driving information, the driving information including at least one of control information and auxiliary information; receiving the driving information from the remote driving terminal; and performing a controlled driving operation or an auxiliary driving operation in accordance with the driving information.

### CROSS-REFERENCE TO RELATED APPLICATION

The present application claims a priority of the Chinese patent application No. 201710867195.3 filed on Sep. 22, 2017, which is incorporated herein by reference in its entirety.

### TECHNICAL FIELD

The present disclosure relates to the field of auxiliary driving technology, in particular to a driving method, a vehicle-mounted driving control terminal, a remote driving terminal, and a storage medium.

### BACKGROUND

In a current remote-control driving or auxiliary driving scheme, it is merely able for a remote terminal to display an image collected by a vehicle in a two-dimensional (2D) manner, so it is difficult for an operator to remotely and completely acquire information for controlling or aiding a driving operation.

### SUMMARY

In one aspect, the present disclosure provides in some embodiments a driving method for use in a vehicle-mounted driving terminal, including steps of: collecting vehicle information in real time, the vehicle information including whole-view information about a driving scene; transmitting the vehicle information to a remote driving terminal, so that the remote driving terminal generates and displays a current virtual reality scene of the vehicle in accordance with the vehicle information and receives a control instruction to generate driving information, the driving information including at least one of control information and auxiliary information; receiving the driving information from the remote driving terminal; and performing a controlled driving operation or an auxiliary driving operation in accordance with the driving information.

In a possible embodiment of the present disclosure, the vehicle information further includes failure information, and the step of performing the controlled driving operation or the auxiliary driving operation in accordance with the driving information includes performing an automatic maintenance operation or an auxiliary maintenance operation in accordance with the driving information.

In a possible embodiment of the present disclosure, subsequent to the step of transmitting the vehicle information to the remote driving terminal so that the remote driving terminal generates and displays the current virtual reality scene of the vehicle in accordance with the vehicle information and receives the control instruction to generate driving information, the driving method further includes monitoring whether or not the driving information has been received regularly.

In a possible embodiment of the present disclosure, the driving method further includes continuously receiving the driving information from the remote driving terminal in the case that the driving information has been received regularly, and switching the vehicle to an automatic driving mode or a normal driving mode in the case that the driving information has not been received regularly.

In a possible embodiment of the present disclosure, subsequent to the step of receiving the driving information from the remote driving terminal, the driving method further includes: determining whether or not a reception time period for the driving information exceeds a first time delay threshold in accordance with first timestamp information; in the case that the reception time period for the driving information exceeds the first time delay threshold, continuously receiving the driving information from the remote driving terminal; and in the case that the reception time period for the driving information does not exceed the first time delay threshold, performing the controlled driving operation or the auxiliary driving operation in accordance with the driving information.

In another aspect, the present disclosure provides in some embodiments a vehicle-mounted driving terminal, including: one or more processors; and a memory configured to store therein one or more programs. The one or more programs are executed by the one or more processors, so as to: collect vehicle information in real time, the vehicle information including whole-view information about a driving scene; transmit the vehicle information to a remote driving terminal, so that the remote driving terminal generates and displays a current virtual reality scene of the vehicle in accordance with the vehicle information and receives a control instruction to generate driving information, the driving information including at least one of control information and auxiliary information; receive the driving information from the remote driving terminal; and perform a controlled driving operation or an auxiliary driving operation in accordance with the driving information.

In a possible embodiment of the present disclosure, the vehicle information further includes failure information, and the processor is further configured to perform an automatic maintenance operation or an auxiliary maintenance operation in accordance with the driving information.

In a possible embodiment of the present disclosure, subsequent to transmitting the vehicle information to the remote driving terminal so that the remote driving terminal generates and displays the current virtual reality scene of the vehicle in accordance with the vehicle information and receives the control instruction to generate driving information, the processor is further configured to monitor whether or not the driving information has been received regularly.

In a possible embodiment of the present disclosure, the processor is further configured to continuously receive the driving information from the remote driving terminal in the case that the driving information has been received regularly, and switch a vehicle to an automatic driving mode or a normal driving mode in the case that the driving information has not been received regularly.

In a possible embodiment of the present disclosure, subsequent to receiving the driving information from the remote driving terminal, the processor is further configured to: determine whether or not a reception time period for the driving information exceeds a first time delay threshold in accordance with first timestamp information; in the case that the reception time period for the driving information exceeds the first time delay threshold, continuously receive the driving information from the remote driving terminal; and in the case that the reception time period for the driving information does not exceed the first time delay threshold, perform the controlled driving operation or the auxiliary driving operation in accordance with the driving information.

In yet another aspect, the present disclosure provides in some embodiments a driving method for use in a remote driving terminal, including steps of: receiving vehicle information collected by and transmitted from a vehicle-mounted driving terminal in real time, the vehicle information including whole-view information about a driving scene; generating and displaying a current virtual reality scene of a vehicle in accordance with the vehicle information; receiving a control instruction so as to generate driving information, the driving information including at least one of control information and auxiliary information; and returning the driving information to the vehicle-mounted driving terminal, so that the vehicle-mounted driving terminal performs a controlled driving operation or an auxiliary driving operation in accordance with the driving information.

In a possible embodiment of the present disclosure, the vehicle information further includes failure information, and the vehicle-mounted driving terminal further performs an automatic maintenance operation or an auxiliary maintenance operation in accordance with the driving information.

In a possible embodiment of the present disclosure, subsequent to the step of generating and displaying the current virtual reality scene of the vehicle in accordance with the vehicle information, the driving method further includes receiving a display instruction so as to display an image at a corresponding viewing angle.

In a possible embodiment of the present disclosure, subsequent to the step of generating and displaying the current virtual reality scene of the vehicle in accordance with the vehicle information, the driving method further includes receiving a display instruction so as to display one or more types of information contained in the vehicle information.

In a possible embodiment of the present disclosure, subsequent to the step of receiving the vehicle information collected by and transmitted from the vehicle-mounted driving terminal in real time, the driving method further includes: determining whether or not a transmission time period for the vehicle information exceeds a second time delay threshold in accordance with second timestamp information; in the case that the transmission time period for the vehicle information exceeds the second time delay threshold, continuously receiving the vehicle information collected by and transmitted from the vehicle-mounted driving terminal; and in the case that the transmission time period for the vehicle information does not exceed the second time delay threshold, generating and displaying the current virtual reality scene of the vehicle in accordance with the vehicle information.

In still yet another aspect, the present disclosure provides in some embodiments a remote driving terminal, including: one or more processors; and a memory configured to store therein one or more programs. The one or more programs are executed by the one or more processors, so as to: receive vehicle information collected by and transmitted from a vehicle-mounted driving terminal in real time, the vehicle information including whole-view information about a driving scene; generate and display a current virtual reality scene of a vehicle in accordance with the vehicle information; receive a control instruction so as to generate driving information, the driving information including at least one of control information and auxiliary information; and return the driving information to the vehicle-mounted driving terminal, so that the vehicle-mounted driving terminal performs a controlled driving operation or an auxiliary driving operation in accordance with the driving information.

In a possible embodiment of the present disclosure, the vehicle information further includes failure information, and the vehicle-mounted driving terminal further performs an automatic maintenance operation or an auxiliary maintenance operation in accordance with the driving information.

In a possible embodiment of the present disclosure, subsequent to generating and displaying the current virtual reality scene of the vehicle in accordance with the vehicle information, the processor is further configured to receive a display instruction so as to display an image at a corresponding viewing angle.

In a possible embodiment of the present disclosure, subsequent to generating and displaying the current virtual reality scene of the vehicle in accordance with the vehicle information, the processor is further configured to receive a display instruction so as to display one or more types of information contained in the vehicle information.

In a possible embodiment of the present disclosure, subsequent to receiving the vehicle information collected by and transmitted from the vehicle-mounted driving terminal in real time, the processor is further configured to: determine whether or not a transmission time period for the vehicle information exceeds a second time delay threshold in accordance with second timestamp information; in the case that the transmission time period for the vehicle information exceeds the second time delay threshold, continuously receive the vehicle information collected by and transmitted from the vehicle-mounted driving terminal; and in the case that the transmission time period for the vehicle information does not exceed the second time delay threshold, generate and display the current virtual reality scene of the vehicle in accordance with the vehicle information.

### BRIEF DESCRIPTION OF THE DRAWINGS

The other features, objects and advantages of the present disclosure will become more apparent with reference to the following drawings.

FIG. 1 is a flow chart of a driving method according to one embodiment of the present disclosure;

FIG. 2 is another flow chart showing the driving method according to one embodiment of the present disclosure;

FIG. 3 is yet another flow chart showing the driving method according to one embodiment of the present disclosure;

FIG. 4 is still yet another flow chart showing the driving method according to one embodiment of the present disclosure;

FIG. 5 is a schematic view showing a vehicle-mounted driving terminal according to one embodiment of the present disclosure;

FIG. 6 is another schematic view showing the vehicle-mounted driving terminal according to one embodiment of the present disclosure;

FIG. 7 is yet another schematic view showing the vehicle-mounted driving terminal according to one embodiment of the present disclosure;

FIG. 8 is still yet another schematic view showing the vehicle-mounted driving terminal according to one embodiment of the present disclosure;

FIG. 9 is a flow chart of a driving method according to one embodiment of the present disclosure;

FIG. 10 is another flow chart showing the driving method as shown in FIG. 9 according to one embodiment of the present disclosure;

FIG. 11 is a schematic view showing a display control logic of Step S24 in the method as shown in FIG. 10;

FIG. 12 is yet another flow chart showing the driving method according to one embodiment of the present disclosure;

FIG. 13 is still yet another flow chart showing the driving method according to one embodiment of the present disclosure;

FIG. 14 is a schematic view showing a remote driving terminal according to one embodiment of the present disclosure;

FIG. 15 is another schematic view showing the remote driving terminal as shown in FIG. 14 according to one embodiment of the present disclosure; and

FIG. 16 is a schematic view showing an electronic device according to one embodiment of the present disclosure.

### DETAILED DESCRIPTION OF EMBODIMENTS

The present disclosure will be described hereinafter in conjunction with the drawings and embodiments. The following embodiments are for illustrative purposes only, but shall not be used to limit the scope of the present disclosure. It should be appreciated that, for ease of description, parts related to the invention are merely shown in the drawings. It should be further appreciated that, in the case of no conflict, the embodiments of the present disclosure and the features therein may be combined in any form.

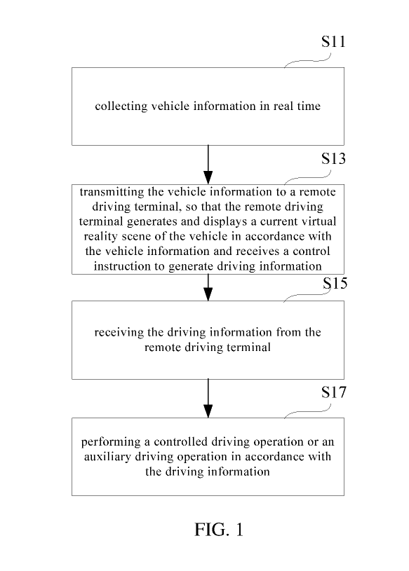

The present disclosure provides in some embodiments a driving method for use in a vehicle-mounted driving terminal which, as shown in FIG. 1, includes the following steps.

Step S11: collecting vehicle information in real time. To be specific, the vehicle information at least includes whole-view information about a driving scene, so that a remote driving terminal may generate a virtual reality scene in accordance with the vehicle information. In addition, the vehicle information may further include one or more of information about instrument of the vehicle, information about an internal environment of the vehicle (e.g., temperature and humidity), information about an external environment of the vehicle (e.g., wind resistance and weather), positioning information (e.g., Global Positioning System (GPS)), and navigation information.

The vehicle information may be collected by a device already existing in the vehicle, e.g., a camera, a sensor or a positioning module, or an additional dedicated device. For example, in the case that the whole-view image cannot be collected by the camera already existing in the vehicle, several common cameras or a whole-view camera may be provided.

Step S13: transmitting the vehicle information to a remote driving terminal, so that the remote driving terminal generates and displays a current virtual reality scene of the vehicle in accordance with the vehicle information and receives a control instruction to generate driving information.

To be specific, in the embodiments of the present disclosure, two driving modes may be supported, i.e., a remote driving mode where a driving operation of the vehicle is controlled by the remote driving terminal, and a remote auxiliary driving mode where auxiliary information is provided from the remote driving terminal to a driver so as to perform the auxiliary driving operation.

In the remote driving mode, the driving information may merely include control information for controlling the driving operation of the vehicle, or may include both the control information and the auxiliary information. The auxiliary information may include information of different types, e.g., image information, voice information and video information, and it is mainly used for communication with a passenger inside the vehicle in the remote driving mode.

In the remote auxiliary driving mode, the driving information may include the auxiliary information for aiding the driver in the driving operation, rather than the control information.

Step S15: receiving the driving information from the remote driving terminal.

Step S17: performing a controlled driving operation or an auxiliary driving operation in accordance with the driving information.

To be specific, in the remote driving mode, the control information contained in the driving information may be parsed and converted into the control instruction, which is executed by an electronic control unit (ECU) of the vehicle so as to control the vehicle. In the case that driving information further includes the auxiliary information, the auxiliary information may also be outputted so as to communicate with the passenger in the vehicle.

In the remote auxiliary driving mode, the auxiliary information may be directly outputted so as to aid the driver in the driving operation.

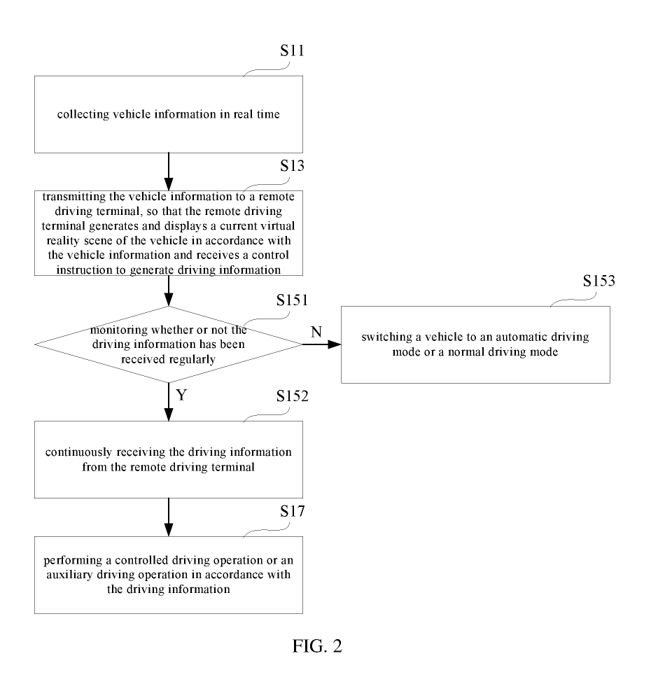

As shown in FIG. 2, in a possible embodiment of the present disclosure, Step S15 includes: Step S151 of monitoring whether or not the driving information has been received regularly; Step S152 of continuously receiving the driving information from the remote driving terminal in the case that the driving information has been received regularly; and Step S153 of switching the vehicle to an automatic driving mode or a normal driving mode in the case that the driving information has not been received regularly.

The vehicle may move within a relatively large range, and sometimes the vehicle-mounted driving terminal is incapable of communicating with the remote driving terminal in a perfect manner. In order to ensure the driving security, especially in the remote driving mode, whether or not the driving information has been received regularly may be monitored so as to determine a communication state. In the case that the driving information has not been received regularly in the remote driving mode, the vehicle may be automatically switched to be in an automatic driving mode, or in the case that the driving information has not been received regularly in the remote auxiliary driving mode, the vehicle may be automatically switched to be in a normal driving mode.

In addition, the driving mode may be controlled using any other monitoring ways known in the art (e.g., by monitoring whether or not the driving information has been received within several consecutive information transmission/reception periods) so as to ensure the driving security, with an identical or similar technical effect.

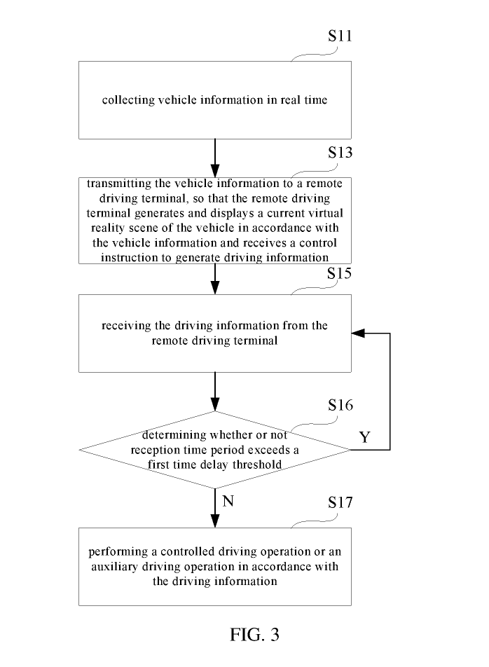

As shown in FIG. 3, in a possible embodiment of the present disclosure, the driving information includes first timestamp information. The driving method further includes Step S16 of determining whether or not a reception time period for the driving information exceeds a first time delay threshold in accordance with the first timestamp information, in the case that the reception time period for the driving information exceeds the first time delay threshold, returning to Step S15, and in the case that the reception time period for the driving information does not exceed the first time delay threshold, proceeding to Step S17.

To be specific, the vehicle-mounted driving terminal may be in communication with the remote driving terminal continuously. In the case that the driving information contains too large data volume within a certain information transmission/reception period or interference occurs for the driving information, the reception of the driving information may be delayed for a too long time period. At this time, the driving security may be directly adversely affected in the remote driving mode, or the driver may be misled in the remote auxiliary driving mode. In addition, due to the time delay, a current piece of driving information and a next piece of driving information may be received by the vehicle-mounted driving terminal simultaneously, so a computational burden of the vehicle-mounted driving terminal may increase.

Through the first time delay threshold, it is able to determine whether or not the reception of the driving information containing the first timestamp information is delayed, thereby to prevent the driving security from being adversely affected by the delayed reception of the driving information and prevent the computational burden of the vehicle-mounted driving terminal from increasing due to a data jam. In addition, in the remote driving mode, it is able to further ensure the driving security in conjunction with the above-mentioned step of monitoring the communication state.

In a possible embodiment of the present disclosure, the vehicle information collected in Step S11 further includes second timestamp information. The remote driving terminal may determine whether or not a transmission time period for the vehicle information exceeds a second time delay threshold in accordance with the second timestamp information. In the case that the transmission time period for the vehicle information exceeds the second time delay threshold, the remote driving terminal may wait for the reception for a next piece of vehicle information.

To be specific, similar to the scheme for solving the problem of the reception delay in FIG. 3, the vehicle information may include the second timestamp information, and the remote driving terminal may determine whether or not the transmission of the vehicle information is delayed in accordance with the second time delay threshold, so as to prevent the driving security from being adversely affected by the delayed transmission and prevent a computational burden of the remote driving terminal from increasing due to a data jam. In addition, in the remote driving mode, it is able to further ensure the driving security in conjunction with the above-mentioned step of monitoring the communication state.

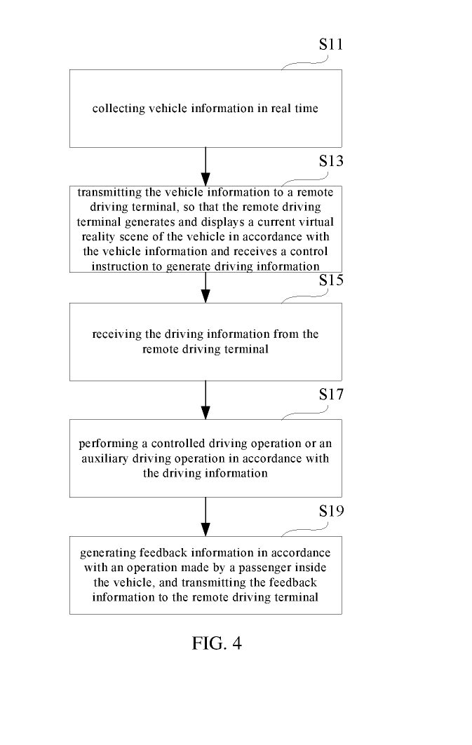

As shown in FIG. 4, in a possible embodiment of the present disclosure, the driving method may further include Step S19 of generating feedback information in accordance with an operation made by a passenger inside the vehicle, and transmitting the feedback information to the remote driving terminal, so that the remote driving terminal may transmit the driving information to the vehicle for the driver's reference.

To be specific, the operation made by the passenger inside the vehicle may include taking photos, shooting videos, inputting voice/video information, or capturing positioning/navigation images.

In a possible embodiment of the present disclosure, the vehicle information collected in Step S11 may further include failure information. Step S17 may further include performing an automatic maintenance operation or an auxiliary maintenance operation in accordance with the driving information.

To be specific, the failure information may be failure information detected by the ECU, an image captured by the camera about a position or member where a failure occurs, or any information related to the failure and collected by any other sensor, e.g., smoke alarm information, in-vehicle temperature alarm information, or in-vehicle humidity alarm information.

Depending on the specific failure and a maintenance capability of the driver or any passenger inside the vehicle, the automatic maintenance operation (in the remote driving mode) or the auxiliary maintenance operation (in the remote auxiliary driving mode) may be selected. In addition, in the case that it is impossible to perform the automatic maintenance operation and the auxiliary maintenance operation, an alarm operation may be performed.

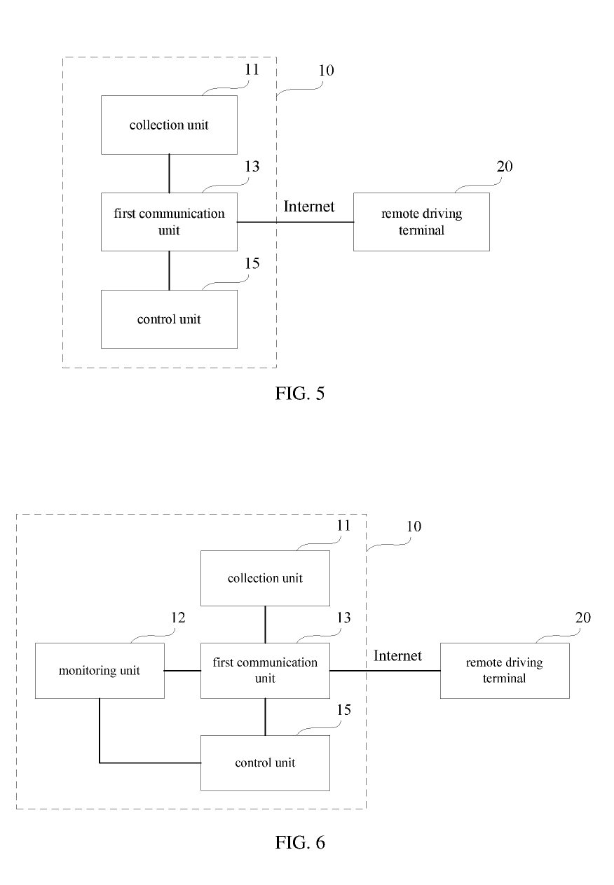

As shown in FIG. 5, the present disclosure further provides in some embodiments a vehicle-mounted driving terminal 10. The vehicle-mounted driving terminal 10 may be used to implement the driving method in FIG. 1.

As shown in FIG. 5, the vehicle-mounted driving terminal 10 includes a collection unit 11, a first communication unit 13 and a control unit 15. The collection unit 11 is configured to collect vehicle information in real time, and the vehicle information includes whole-view information about a driving scene. The first communication unit 13 is configured to transmit the vehicle information to a remote driving terminal 20, so that the remote driving terminal 20 generates and displays a current virtual reality scene of the vehicle in accordance with the vehicle information and receives a control instruction to generate driving information. The driving information includes at least one of control information and auxiliary information. The first communication unit 13 is further configured to receive the driving information from the remote driving terminal 20. The control unit 15 is configured to perform a controlled driving operation or an auxiliary driving operation in accordance with the driving information.

To be specific, in some embodiments of the present disclosure, the vehicle-mounted driving terminal 10 and the units thereof may be arranged independent of each other inside or on a vehicle body, and may communicate with an ECU and the remote driving terminal 20. In some other embodiments of the present disclosure, the vehicle-mounted driving terminal 10 and the units thereof may be integrated into the vehicle body, and may be arranged independent of, and communicate through a standard interface with, the ECU or coupled to the ECU.

A remote driving principle of the vehicle-mounted driving terminal 10 and the units thereof may refer to the method in FIG. 1, and thus will not be particularly defined herein.

The vehicle-mounted driving terminal in FIG. 6 may be used to implement the method in FIG. 2.

As shown in FIG. 6, in a possible embodiment of the present disclosure, the vehicle-mounted driving terminal 10 further includes a monitoring unit 12 configured to monitor whether or not the driving information has been received by the first communication unit 13 regularly. To be specific, in the case that the driving information has not been received by the first communication unit 13 regularly, the monitoring unit 12 may notify the control unit 15 to switch the vehicle to an automatic driving mode or a normal driving mode.

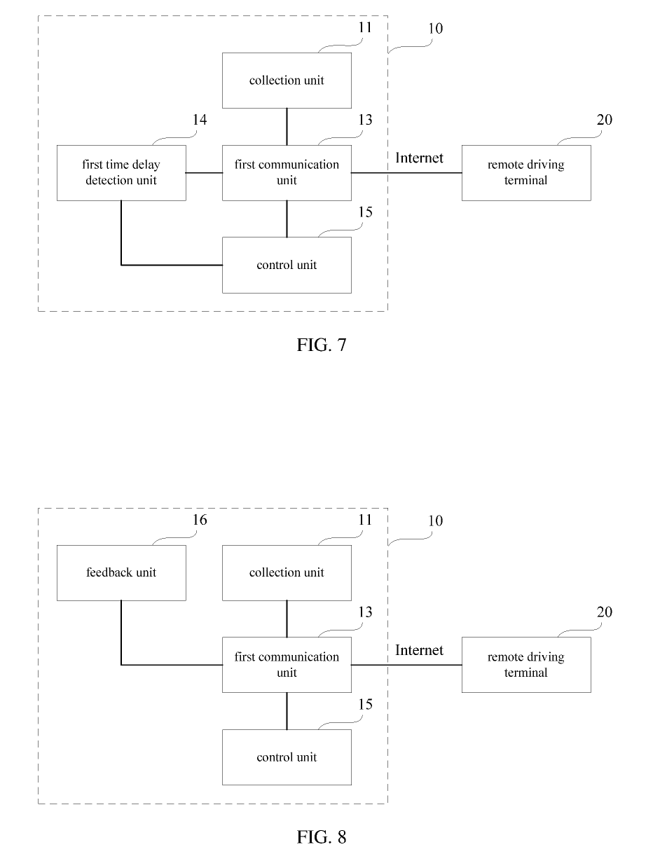

The vehicle-mounted driving terminal in FIG. 7 may be used to implement the method in FIG. 3.

As shown in FIG. 7, in a possible embodiment of the present disclosure, the driving information includes first timestamp information. The vehicle-mounted driving terminal 10 further includes a first time delay detection unit 14 configured to determine whether or not a reception time period for the driving information exceeds a first time delay threshold in accordance with the first timestamp information, and in the case that the reception time period for the driving information exceeds the first time delay threshold, not transmit a current piece of driving information to the control unit 15 and wait for the reception of a next piece of driving information through the first communication unit 13.

In a possible embodiment of the present disclosure, the vehicle information collected by the collection unit 11 may further include at least one of instrument information, environment information, positioning information, navigation information and second timestamp information. The remote driving terminal 20 may determine whether or not a transmission time period for a current piece of vehicle information exceeds a second time delay threshold in accordance with the second timestamp information, and in the case that the transmission time period for the current piece of vehicle information exceeds the second time delay threshold, wait for the reception of a next piece of vehicle information.

The vehicle-mounted driving terminal 10 in FIG. 8 may be used to implement the method in FIG. 4.

As shown in FIG. 8, in a possible embodiment of the present disclosure, the vehicle-mounted driving terminal 10 further includes a feedback unit 16 configured to generate feedback information in accordance with an operation made by a passenger inside the vehicle. The first communication unit 13 is further configured to transmit the feedback information to the remote driving terminal 20, so that the remote driving terminal 20 may transmit the driving information to the vehicle for the driver's reference.

In a possible embodiment of the present disclosure, the vehicle information collected by the collection unit 11 further includes failure information. The control unit 15 is further configured to perform an automatic maintenance operation or an auxiliary maintenance operation in accordance with the driving information.

A driving principle of the vehicle-mounted driving terminal 10 may also refer to the methods mentioned hereinabove, and thus will not be particularly defined herein.

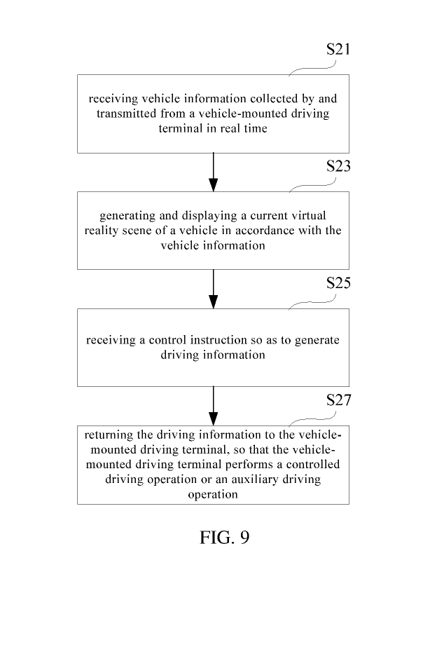

The present disclosure further provides in some embodiments another driving method for use in a remote driving terminal which, as shown in FIG. 9, includes the following steps.

Step S21: receiving vehicle information collected by and transmitted from a vehicle-mounted driving terminal in real time. The vehicle information includes whole-view information about a driving scene. To be specific, the vehicle information may further include instrument information, environment information, positioning information and navigation information. This step may refer to the method in FIG. 1, and thus will not be particularly defined herein.

Step S23: generating and displaying a current virtual reality scene of a vehicle in accordance with the vehicle information.

To be specific, in a possible embodiment of the present disclosure, the vehicle information may be parsed through a virtual reality (VR) display device. The current virtual reality scene of the vehicle may be generated and displayed in accordance with the whole-view information about the driving scene. Then, a function of displaying any other information contained in the vehicle information in the virtual reality scene may be provided (parts or all of the information may be directly loaded into the virtual reality scene, or the information may be displayed in accordance with an operation made by a remote driver).

In another possible embodiment of the present disclosure, Step S23 may also be performed through a VR display device connected to a host, i.e., the host may be used to parse and process the data and generate the virtual reality scene. A head-mounted device may be used to merely display the virtual reality scene, or it may be further used to aid the host in the processing of a part of the data.

Step S25: receiving a control instruction so as to generate driving information. The driving information includes at least one of control information and auxiliary information. To be specific, in the embodiments of the present disclosure, a control instruction from a user may be received by a hand-held device (e.g., a Bluetooth remote controller) in communication with the VR display device, and operation information corresponding to the control instruction may be transmitted to the VR device. In addition, the VR display device may also be used to receive such information as voice information inputted by the remote driver.

In another possible embodiment of the present disclosure, a control instruction from the remote driver may be received through detecting a specific operational motion of the user using the VR display device, or pressing buttons on the VR display devices, or a combination thereof.

In the remote driving mode, the VR display device (or the host) may generate the control information in accordance with the operation information, and generate the auxiliary information in accordance with the other information, thereby to finally generate the driving information. In the remote auxiliary driving mode, the VR display device (or the host) may generate the auxiliary information in accordance with all the information as the driving information.

Step S27: returning the driving information to the vehicle-mounted driving terminal, so that the vehicle-mounted driving terminal performs a controlled driving operation or an auxiliary driving operation in accordance with the driving information.

To be specific, a driving principle of the vehicle-mounted driving terminal may refer to the method in FIG. 1.

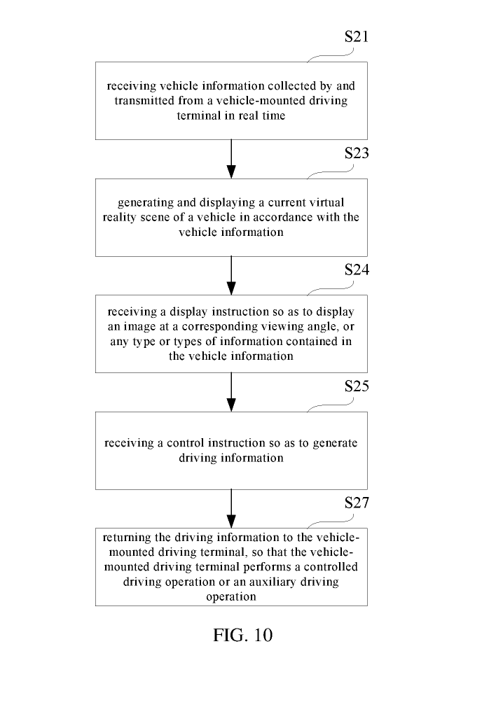

As shown in FIG. 10, in a possible embodiment of the present disclosure, the driving method may further include Step S24 of receiving a display instruction so as to display an image at a corresponding viewing angle, or any type or types of information contained in the vehicle information.

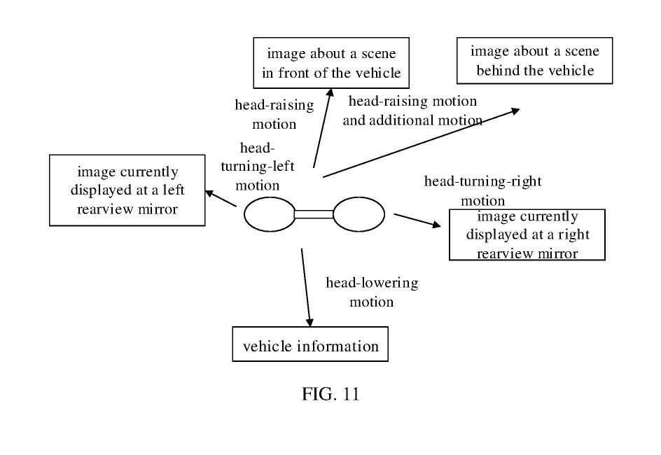

As shown in FIG. 11 which shows a display control logic in Step S24 of the method in FIG. 10, in a possible embodiment of the present disclosure, a three-axis gyroscope of the VR display device may be used to detect a motion of a head of the remote driver, so as to receive the display instruction. For example, in the case that a head-raising motion has been detected, an image about a scene in front of the vehicle may be displayed. In the case that the head-raising motion and an additional motion (e.g., a button of a remote controller or a head-mounted device has been pressed) have been detected simultaneously, an image about a scene behind the vehicle may be displayed. In the case that a head-turning-left motion has been detected, an image that is currently displayed at a left rearview mirror may be displayed. In the case that a head-turning-right motion has been detected, an image that is currently displayed at a right rearview mirror maybe displayed. In the case that head-lowering motion has been detected, the vehicle information may be displayed or may not be displayed.

The above display control logics are merely for illustrative purposes, and different display control logics may be configured in accordance with the practical need, so as to achieve an identical or similar technical effect.

In another possible embodiment of the present disclosure, the motion of the head and an operation made by the handheld control device may be detected simultaneously, so as to receive the display instruction. In addition, the operation made by the handheld control device may be detected separately, so as to receive the display instruction.

In a possible embodiment of the present disclosure, the driving information generated in Step S25 further includes first timestamp information. The vehicle-mounted driving terminal may determine whether or not a transmission time period for a current piece of driving information exceeds a first time delay threshold in accordance with the first timestamp information, and in the case that the transmission time period for the current piece of driving information exceeds the first time delay threshold, the vehicle-mounted driving terminal may wait for the reception of a next piece of driving information. This step may refer to the method in FIG. 3, and thus will not be particularly defined herein.

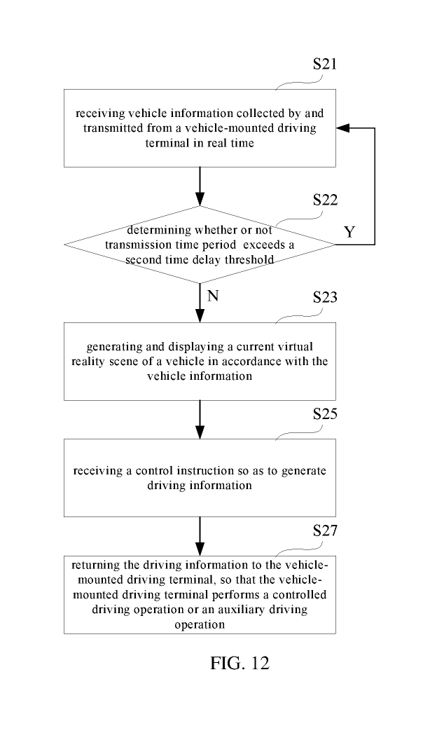

As shown in FIG. 12, in a possible embodiment of the present disclosure, the vehicle information received in Step S21 further includes second timestamp information. The driving method may further include Step S22 of determining whether or not a transmission time period for a current piece of vehicle information exceeds a second time delay threshold in accordance with the second timestamp information, in the case that the transmission time period for the current piece of vehicle information exceeds the second time delay threshold, returning to Step S21 and waiting for the reception of a next piece of vehicle information, and in the case that the transmission time period for the current piece of vehicle information does not exceed the second time delay threshold, proceeding to Step S23.

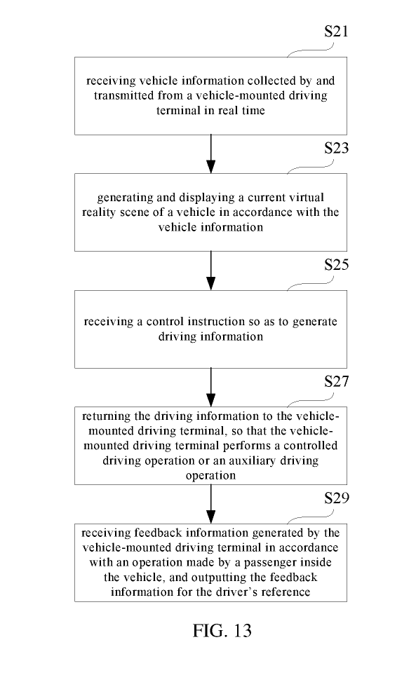

As shown in FIG. 13, in a possible embodiment of the present disclosure, the driving method may further include Step S29 of receiving feedback information generated by the vehicle-mounted driving terminal in accordance with the operation made by the passenger inside the vehicle, and outputting the feedback information for the driver's reference.

In a possible embodiment of the present disclosure, the vehicle information received in Step S21 may further include failure information, and the vehicle-mounted driving terminal may perform an automatic maintenance operation or an auxiliary maintenance operation in accordance with the driving information generated in Step S25.

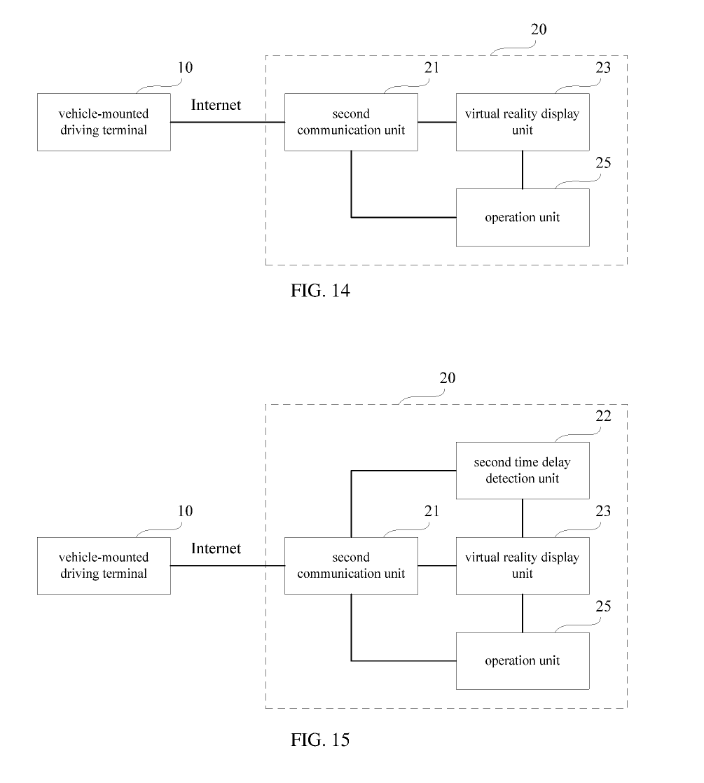

As shown in FIG. 14, the present disclosure further provides in some embodiments a remote driving terminal 20 for implementing the methods in FIG. 9, FIG. 10 and FIG. 13.

As shown in FIG. 14, the remote driving terminal 20 includes a second communication unit 21, a virtual reality display unit 23 and an operation unit 25.

The second communication unit 21 is configured to receive vehicle information collected by and transmitted from a vehicle-mounted driving terminal 10 in real time, and return driving information to the vehicle-mounted driving terminal 10, so that the vehicle-mounted driving terminal 10 performs a controlled driving operation or an auxiliary driving operation in accordance with the driving information. The vehicle information includes whole-view information about a driving scene. The virtual reality display unit 23 is configured to generate and display a current virtual reality scene of a vehicle in accordance with the vehicle information. The operation unit 25 is configured to receive a control instruction so as to generate the driving information. The driving information includes at least one of control information and auxiliary information.

In a possible embodiment of the present disclosure, the remote driving terminal 20 includes a VR display device, and the second communication unit 21, the virtual reality display unit 23 and the operation unit 25 are integrated into the VR display device.

In a possible embodiment of the present disclosure, apart from the VR display device, the remote driving terminal 20 may further include a handheld control device or a console in communication with the VR display device, i.e., the operation unit may further include the handheld control device or console.

In yet another possible embodiment of the present disclosure, the remote driving terminal 20 may include a host, a VR display device, and a hand-held control device or console (optional). Different from the description above, a data processing sub-unit (not shown) of the virtual reality display unit 23 and the second communication unit 21 are configured in the host. In addition, the data processing sub-unit of the virtual reality display unit 23 may be configured in each of the host and the VR display device, so as to enable the VR display device to aid the host in the processing of a part of the data.

A remote driving principle of the remote driving terminal 20 and the units thereof may refer to the method in FIG. 9, and thus will not be particularly defined herein.

In a possible embodiment of the present disclosure, the operation unit 25 is further configured to receive a display instruction so as to control the virtual reality display unit 23 to display an image at a corresponding viewing angle, or display any type or types of information contained in the vehicle information.

In a possible embodiment of the present disclosure, the driving information generated by the operation unit 25 includes first timestamp information. The vehicle-mounted driving terminal 10 may determine whether or not a transmission time period for a current piece of driving information exceeds a first time delay threshold in accordance with the first timestamp information, and in the case that the transmission time period for the current piece of driving information, the vehicle-mounted driving terminal 10 may wait for the reception of a next piece of driving information.

In a possible embodiment of the present disclosure, the second communication unit 21 is further configured to receive feedback information generated by the vehicle-mounted driving terminal 10 in accordance with an operation made by the passenger inside the vehicle. The virtual reality display unit 23 is further configured to output the feedback information for the driver's reference.

In a possible embodiment of the present disclosure, the vehicle information received by the second communication unit 21 further includes failure information. The vehicle-mounted driving device 10 may perform an automatic maintenance operation or an auxiliary maintenance operation in accordance with the driving information generated by the operation unit 25.

As shown in FIG. 15, the driving remote terminal may be used to implement the method in FIG. 12.

As shown in FIG. 15, in a possible embodiment of the present disclosure, the vehicle information received by the second communication unit 21 further includes second timestamp information. The remote driving terminal 20 further includes a second time delay detection unit 22 configured to determine whether or not a transmission time period for a current piece of vehicle information exceeds a second time delay threshold in accordance with the second timestamp information, and in the case that the transmission time period for the current piece of vehicle information, wait for the reception of a next piece of vehicle information.

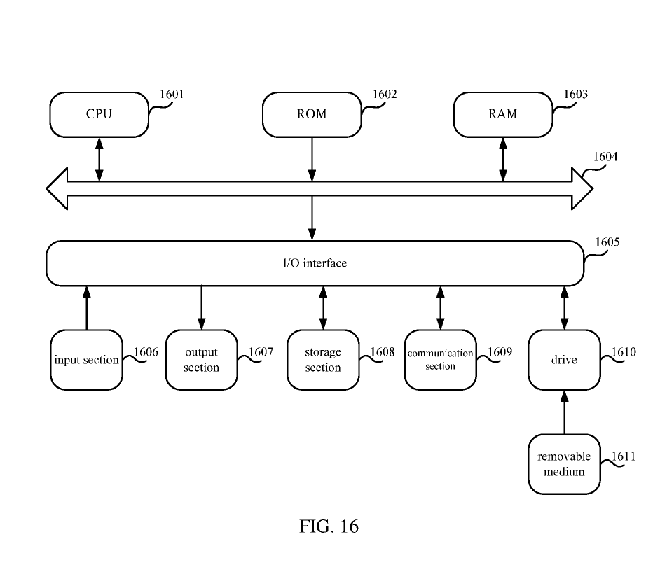

As shown in FIG. 16, the present disclosure further provides in some embodiments an electronic device 1600, including one or more central processing units (CPUs) 1601 which is configured to execute various appropriate processings in accordance with a program stored in a read only memory (ROM) 1602 or a program loaded from a storage section 1608 to a random access memory (RAM) 1603. Various programs and data for the operation of the electronic device 1600 may also be stored in the RAM 1603. The CPU 1601, the ROM 1602 and the RAM 1603 are connected to each other via a bus 1604. An input/output (I/O) interface 1605 is also connected to the bus 1604.

The following members are connected to the I/O interface 1605: an input section including a keyboard and a mouse; an output section including a cathode ray tube (CRT), a liquid crystal display (LCD) and a speaker; the storage section 1608 including a hard disk; and a communication section 1609 including a network interface card such as a local area network (LAN) card or a demodulator. The communication section 1609 is configured to perform communication processing via a network such as Internet. A driver 1610 is also connected to the I/O interface 1605 in accordance with the practical need. A removable medium 1611, e.g., a magnetic disk, an optical disk, a magnetooptical disk or a semiconductor memory, is installed on the driver 1601 in accordance with the practical need, so that the driver 1610 may read a computer program stored therein and install it into the storage section 1608 in accordance with the practical need.

Especially, the above-mentioned driving method may be implemented as a computer software program. For example, the present disclosure further provides in some embodiments a computer program product, including a computer program physically stored in a computer-readable medium. The computer program includes a program code for implementing the driving method. The computer program may be downloaded from a network through the communication section 1609 and installed in the computer program product, and/or downloaded from the removable medium 1611 and installed in the computer program product.

The present disclosure further provides in some embodiments a computer-readable storage medium which may be contained in the above-mentioned device, or provided separately but not be contained in the electronic device. The computer-readable storage medium is configured to store therein one or more programs which are executed by one or more processors so as to implement the above-mentioned driving method.

Possible architecture, functions and operations of the system, method and computer program product in the embodiments of the present disclosure are shown in the flow charts and block diagrams. Each block in the flow charts or block diagrams may represent a part of a module, a program segment or a code. The part of the module, program segment or code may include one or more executable instructions for achieving a prescribed logical function. It should be appreciated that, in some substitutions, the steps represented by the blocks may be performed in an order different from that shown in the drawings. For example, the steps represented by two blocks connected to each other may actually be performed substantially simultaneously, or in an opposite order, depending on the functions involved therein. It should be also appreciated that, each block in the block diagrams and/or the flow charts, and a combination of the blocks may be implemented through a dedicated hardware-based system capable of achieving a prescribed function or operation, or through dedicated hardware in conjunction with a computer instruction.

The units or modules involved in the embodiments of the present disclosure may be implemented in the form of software or hardware. In addition, the units or modules may also be arranged in a processor. For example, the units may be software programs installed in a computer or a mobile smart electronic device, or hardware units arranged separately. Names of the units or modules shall not be construed as limiting the units or modules themselves in some cases.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A driving method for use in a vehicle-mounted driving terminal, comprising:
collecting vehicle information in real time, the vehicle information comprising whole-view information about a driving scene;
transmitting the vehicle information to a remote driving terminal, so that the remote driving terminal generates and displays a current virtual reality scene of the vehicle in accordance with the vehicle information and receives a control instruction to generate driving information, the driving information comprising at least one of control information and auxiliary information;
receiving the driving information from the remote driving terminal; and
performing a controlled driving operation or an auxiliary driving operation in accordance with the driving information.

2. The driving method according to claim 1, wherein the vehicle information further comprises failure information, and the step of performing the controlled driving operation or the auxiliary driving operation in accordance with the driving information comprises performing an automatic maintenance operation or an auxiliary maintenance operation in accordance with the driving information.

3. The driving method according to claim 1, wherein subsequent to the step of transmitting the vehicle information to the remote driving terminal so that the remote driving terminal generates and displays the current virtual reality scene of the vehicle in accordance with the vehicle information and receives the control instruction to generate driving information, the driving method further comprises monitoring whether or not the driving information has been received regularly.

4. The driving method according to claim 3, further comprising continuously receiving the driving information from the remote driving terminal if the driving information has been received regularly, and switching the vehicle to an automatic driving mode or a normal driving mode if the driving information has not been received regularly.

5. The driving method according to claim 1, wherein subsequent to the step of receiving the driving information from the remote driving terminal, the driving method further comprises:
determining whether or not a reception time period for the driving information exceeds a first time delay threshold in accordance with first timestamp information;
in response to determining that the reception time period for the driving information exceeds the first time delay threshold, continuously receiving the driving information from the remote driving terminal; and
in response to determining that the reception time period for the driving information does not exceed the first time delay threshold, performing the controlled driving operation or the auxiliary driving operation in accordance with the driving information.

6. A vehicle-mounted driving terminal, comprising at least one processor, and a memory configured to store therein one or more programs, wherein the one or more programs are executed by the at least one processor, so as to realize the driving method for use in the vehicle-mounted driving terminal according to claim 1.

7. The vehicle-mounted driving terminal according to claim 6, wherein the vehicle information further comprises failure information, and the processor is further configured to perform an automatic maintenance operation or an auxiliary maintenance operation in accordance with the driving information.

8. The vehicle-mounted driving terminal according to claim 6, wherein subsequent to transmitting the vehicle information to the remote driving terminal so that the remote driving terminal generates and displays the current virtual reality scene of the vehicle in accordance with the vehicle information and receives the control instruction to generate driving information, the processor is further configured to monitor whether or not the driving information has been received regularly.

9. The vehicle-mounted driving terminal according to claim 8, wherein the processor is further configured to continuously receive the driving information from the remote driving terminal if the driving information has been received regularly, and switch a vehicle to an automatic driving mode or a normal driving mode if the driving information has not been received regularly.

10. The vehicle-mounted driving terminal according to claim 6, wherein subsequent to receiving the driving information from the remote driving terminal, the processor is further configured to:
determine whether or not a reception time period for the driving information exceeds a first time delay threshold in accordance with first timestamp information;
in response to determining that the reception time period for the driving information exceeds the first time delay threshold, continuously receive the driving information from the remote driving terminal; and
in response to determining that the reception time period for the driving information does not exceed the first time delay threshold, perform the controlled driving operation or the auxiliary driving operation in accordance with the driving information.

11. A driving method for use in a remote driving terminal, comprising:
receiving vehicle information collected by and transmitted from a vehicle-mounted driving terminal in real time, the vehicle information comprising whole-view information about a driving scene;
generating and displaying a current virtual reality scene of a vehicle in accordance with the vehicle information;
receiving a control instruction so as to generate driving information, the driving information comprising at least one of control information and auxiliary information; and
returning the driving information to the vehicle-mounted driving terminal, so that the vehicle-mounted driving terminal performs a controlled driving operation or an auxiliary driving operation in accordance with the driving information.

12. The driving method according to claim 11, wherein the vehicle information further comprises failure information, and the vehicle-mounted driving terminal further performs an automatic maintenance operation or an auxiliary maintenance operation in accordance with the driving information.

13. The driving method according to claim 11, wherein subsequent to the step of generating and displaying the current virtual reality scene of the vehicle in accordance with the vehicle information, the driving method further comprises receiving a display instruction so as to display an image at a corresponding viewing angle.

14. The driving method according to claim 11, wherein subsequent to the step of generating and displaying the current virtual reality scene of the vehicle in accordance with the vehicle information, the driving method further comprises receiving a display instruction so as to display one or more types of information contained in the vehicle information.

15. The driving method according to claim 11, wherein subsequent to the step of receiving the vehicle information collected by and transmitted from the vehicle-mounted driving terminal in real time, the driving method further comprises:
determining whether or not a transmission time period for the vehicle information exceeds a second time delay threshold in accordance with second timestamp information;
in response to determining that the transmission time period for the vehicle information exceeds the second time delay threshold, continuously receiving the vehicle information collected by and transmitted from the vehicle-mounted driving terminal; and
in response to determining that the transmission time period for the vehicle information does not exceed the second time delay threshold,
generating and displaying the current virtual reality scene of the vehicle in accordance with the vehicle information.

16. A remote driving terminal, comprising at least one processor, and a memory configured to store therein one or more programs, wherein the one or more programs are executed by the at least one processor, so as to realize the driving method for use in the remote driving terminal according to claim 11.

17. The remote driving terminal according to claim 16, wherein the vehicle information further comprises failure information, and the vehicle-mounted driving terminal further performs an automatic maintenance operation or an auxiliary maintenance operation in accordance with the driving information.

18. The remote driving terminal according to claim 16, wherein subsequent to generating and displaying the current virtual reality scene of the vehicle in accordance with the vehicle information, the processor is further configured to receive a display instruction so as to display an image at a corresponding viewing angle.

19. The remote driving terminal according to claim 16, wherein subsequent to generating and displaying the current virtual reality scene of the vehicle in accordance with the vehicle information, the processor is further configured to receive a display instruction so as to display one or more types of information contained in the vehicle information.

20. The remote driving terminal according to claim 16, wherein subsequent to receiving the vehicle information collected by and transmitted from the vehicle-mounted driving terminal in real time, the processor is further configured to:
determine whether or not a transmission time period for the vehicle information exceeds a second time delay threshold in accordance with second timestamp information;
in response to determining that the transmission time period for the vehicle information exceeds the second time delay threshold, continuously receive the vehicle information collected by and transmitted from the vehicle-mounted driving terminal; and
in response to determining that the transmission time period for the vehicle information does not exceed the second time delay threshold, generate and display the current virtual reality scene of the vehicle in accordance with the vehicle information.

21. A non-transitory computer-readable storage medium, storing therein one or more programs, wherein the one or more programs are executed by one or more processors so as to implement the driving method according to claim 1.

22. A non-transitory computer-readable storage medium, storing therein one or more programs, wherein the one or more programs are executed by one or more processors so as to implement the driving method according to claim 11.
